(19) United States
(12) Patent Application Publication
(10) Pub. No.: US 2021/0163002 A1
(43) Pub. Date: Jun. 3, 2021

(54) TRAVEL CONTROL APPARATUS OF SELF-DRIVING VEHICLE

(71) Applicant: Honda Motor Co., Ltd., Tokyo (JP)

(72) Inventors: Akira Kito, Wako-shi, Saitama (JP); Yoshiaki Konishi, Wako-shi, Saitama (JP); Toshiyuki Mizuno, Wako-shi, Saitama (JP); Takayuki Kishi, Wako-shi, Saitama (JP)

(21) Appl. No.: 16/770,932

(22) PCT Filed: Sep. 27, 2018
(86) PCT No.: PCT/JP2018/035896

§ 371 Date: Jun. 8, 2020

(30) Foreign Application Priority Data
Dec. 27, 2017 (JP) 2017-252142

(51) Int. Cl. B60W 30/165; F16H 59/60; B60W 30/182; F16H 61/02

(52) U.S. Cl. CPC B60W 30/165; F16H 59/60; B60W 30/182; B60W 2510/10; F16H 2061/0223; B60W 2554/402; F16H 61/0213

(57) ABSTRACT

A travel control apparatus of a self-driving vehicle having a drive power source and a transmission installed in a power transmission path from the drive power source to drive wheels. The travel control apparatus includes a vehicle class detection part detecting a size class of a forward vehicle and a microprocessor. The microprocessor is configured to perform controlling the drive power source and the transmission so as to follow the forward vehicle, recognizing a vehicle type of the forward vehicle in accordance with the size class detected by the vehicle class detection part, and the controlling including controlling a speed ratio of the transmission in accordance with the vehicle type recognized in the recognizing.

### CROSS-REFERENCE TO RELATED APPLICATION

This application is a National Stage of PCT international application Ser. No. PCT/JP2018/035896 filed on Sep. 27, 2018 which designates the United States, incorporated herein by reference, and which is based upon and claims the benefit of priority from Japanese Patent Application No. 2017-252142, filed on Dec. 27, 2017, the entire contents of which are incorporated herein by reference.

### TECHNICAL FIELD

This invention relates to a travel control apparatus of a self-driving vehicle.

### BACKGROUND ART

Conventionally, there is a known apparatus of this type, configured to control a self-driving vehicle so as to follow a forward vehicle with an inter-vehicle distance from the self-driving vehicle to the forward vehicle maintained to a predetermined inter-vehicle distance (for example, see Patent Literature 1).

### CITATION LIST

### Patent Literature

Patent Literature 1: Japanese Unexamined Patent Publication No. 2017-92678

### DISCLOSURE OF INVENTION

### Problems to be Solved by the Invention

However, when the self-driving vehicle follows the forward vehicle of a different vehicle size class from the self-driving vehicle, it is difficult for the self-driving vehicle to optimally follow the forward vehicle due to significant difference between the self-driving vehicle and the forward vehicle in driving performance such as acceleration performance.

### Means for Solving Problem

An aspect of the present invention is a travel control apparatus of a self-driving vehicle having a drive power source, drive wheels and a transmission installed in a power transmission path from the drive power source to the drive wheels. The travel control apparatus includes: a vehicle class detection part configured to detect a size class of a forward vehicle in front of the self-driving vehicle; and an electronic control unit having a microprocessor and a memory. The microprocessor is configured to perform controlling the drive power source and the transmission so as to follow the forward vehicle, recognizing a vehicle type of the forward vehicle in accordance with the size class detected by the vehicle class detection part, and the controlling including controlling a speed ratio of the transmission in accordance with the vehicle type recognized in the recognizing.

### Effect of the Invention

According to the present invention, the self-driving vehicle can travel so as to optimally follow a forward vehicle even when a size class between the self-driving vehicle and the forward vehicle is different.

### BRIEF DESCRIPTION OF THE DRAWINGS

FIG. 1 is a diagram showing a configuration overview of a driving system of a self-driving vehicle to which a travel control apparatus according to an embodiment of the present invention is applied;

FIG. 2 is a block diagram schematically illustrating overall configuration of a vehicle control system having the travel control apparatus according to an embodiment of the present invention;

FIG. 3 is a diagram showing an example of an action plan generated by an action plan generation unit of FIG. 2;

FIG. 4 is a diagram showing an example of a shift map stored in a memory unit of FIG. 2;

FIG. 5 is a block diagram illustrating main configuration of the travel control apparatus according to the embodiment of the present invention; and

FIG. 6 is a flow chart showing an example of processing performed by a controller of FIG. 5.

### DESCRIPTION OF EMBODIMENT

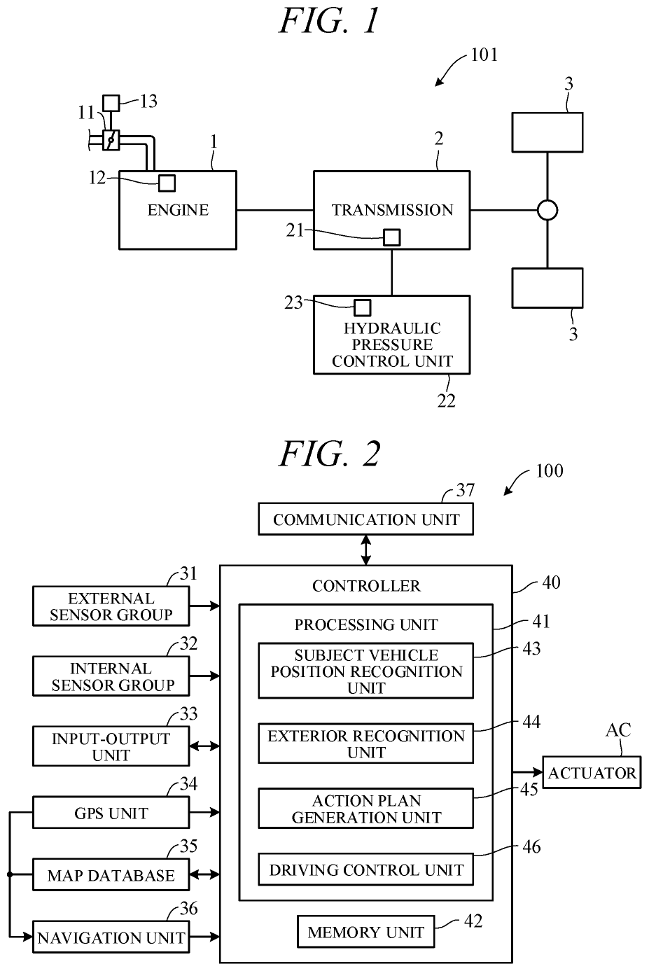

Hereinafter, an embodiment of the present invention is explained with reference to FIGS. 1 to 6. A travel control apparatus according to an embodiment of the present invention is applied to a vehicle (self-driving vehicle) having a self-driving capability. FIG. 1 is a diagram showing a configuration overview of a driving system of a self-driving vehicle 101 incorporating a travel control apparatus according to the present embodiment. Herein, the self-driving vehicle may be sometimes called “subject vehicle” to differentiate it from other vehicles. The vehicle 101 is not limited to driving in a self-drive mode requiring no driver driving operations but is also capable of driving in a manual drive mode by driver operations.

As shown in FIG. 1, the vehicle 101 includes an engine 1 and a transmission 2. The engine 1 is an internal combustion engine (e.g., gasoline engine) wherein intake air supplied through a throttle valve and fuel injected from an injector are mixed at an appropriate ratio and thereafter ignited by a sparkplug or the like to burn explosively and thereby generate rotational power. A diesel engine or any of various other types of engine can be used instead of a gasoline engine. Air intake volume is metered by the throttle valve. An opening angle of the throttle valve 11 (throttle opening angle) is changed by a throttle actuator 13 operated by an electric signal. The opening angle of the throttle valve 11 and an amount of fuel injected from the injector 12 (injection timing and injection time) are controlled by a controller 40 (FIG. 2).

The transmission 2, which is installed in a power transmission path between the engine 1 and drive wheels 3, changes a speed of rotation output from the engine 1, and converts and outputs torque output from the engine 1. The rotation of speed converted by the transmission 2 is transmitted to the drive wheels 3, thereby propelling the vehicle. Optionally, the vehicle 101 can be configured as an electric vehicle or hybrid vehicle by providing a drive motor as a drive power source in place of or in addition to the engine 1.

The transmission 2 is, for example, a stepped transmission enabling stepwise speed ratio (gear ratio) shifting in accordance with multiple (e.g. eight) speed stages. Optionally, a continuously variable transmission enabling stepless speed ratio shifting can be used as the transmission 2. Although omitted in the drawings, power output from the engine 1 can be input to the transmission 2 through a torque converter. The transmission 2 can, for example, incorporate a dog clutch, friction clutch or other engaging element 21. A hydraulic pressure control unit 22 can shift speed stage of the transmission 2 by controlling flow of oil to the engaging element 21. The hydraulic pressure control unit 22 includes a solenoid valve or other valve mechanism operated by electric signals (called “shift actuator 23” for sake of convenience), and an appropriate speed stage can be implemented by changing flow of hydraulic pressure to the engaging element 21 in response to operation of the shift actuator 23.

FIG. 2 is a block diagram schematically illustrating overall configuration of a vehicle control system 100 of the self-driving vehicle 101 to which the travel control apparatus according to an embodiment of the present invention is applied. As shown in FIG. 2, the vehicle control system 100 mainly includes the controller 40, and an external sensor group 31, an internal sensor group 32, an input-output unit 33, a GPS unit 34, a map database 35, a navigation unit 36, a communication unit 37 and actuators AC which are communicably connected with the controller 40.

The term external sensor group 31 herein is a collective designation encompassing multiple sensors for detecting external circumstances constituting subject vehicle ambience data. For example, the external sensor group 31 includes, inter alia, a LIDAR (Light Detection and Ranging) for measuring distance from the vehicle to ambient obstacles by measuring scattered light produced by laser light radiated from the subject vehicle in every direction, a RADAR (Radio Detection and Ranging) for detecting other vehicles and obstacles around the subject vehicle by radiating electromagnetic waves and detecting reflected waves, and a CCD, CMOS or other image sensor equipped on-board cameras for imaging subject vehicle ambience (forward, reward and sideways). The inter-vehicle distance from the subject vehicle to the forward vehicle can be measured by any of LIDAR, RADAR, and the on-board camera.

The term internal sensor group 32 herein is a collective designation encompassing multiple sensors for detecting subject vehicle driving state. For example, the internal sensor group 32 includes, inter alia, a vehicle speed sensor for detecting vehicle speed of the subject vehicle and acceleration sensors for detecting forward-rearward direction acceleration and lateral acceleration of the subject vehicle, respectively, an engine speed sensor for detecting rotational speed of the engine 1, a yaw rate sensor for detecting rotation angle speed around a vertical axis through subject vehicle center of gravity, and a throttle opening sensor for detecting opening angle of the throttle valve 11 (throttle opening angle). The internal sensor group 32 also includes sensors for detecting driver driving operations in manual drive mode, including, for example, accelerator pedal operations, brake pedal operations, steering wheel operations and the like.

The term input-output unit 33 is used herein as a collective designation encompassing apparatuses receiving instructions input by the driver and outputting information to the driver. For example, the input-output unit 33 includes, inter alia, switches which the driver uses to input various instructions, a microphone which the driver uses to input voice instructions, a display for presenting information to the driver via displayed images, and a speaker for presenting information to the driver by voice. The switches include a self/manual drive select switch for instructing either self-drive mode or manual drive mode, and a travel mode select switch for selecting a travel mode.

The self/manual drive select switch, for example, is configured as a switch manually operable by the driver to output instruction of switching between the self-drive mode enabling self-drive functions and the manual drive mode disabling self-drive functions in accordance with an operation of the switch. Optionally, the mode select switch can be configured to instruct switching from manual drive mode to self-drive mode or from self-drive mode to manual drive mode when a predetermined condition is satisfied without operating the mode select switch. In other words, mode select can be performed automatically not manually in response to automatic switching of the mode select switch.

The travel mode select switch, for example, is configured as a switch manually operable by the driver to output an instruction of selecting one of travel modes. The travel modes include normal mode that balances fuel economy performance and power performance, sport mode that prioritizes power performance over fuel economy performance, economy mode that prioritizes fuel economy performance over power performance, and autonomous travel mode that autonomously sets travel mode from among the normal mode, economy mode and sport mode. Travel mode in accordance with operation of the travel mode select switch from among these travel modes is selected and instructed.

Economy mode, normal mode and sport mode can be selected in manual drive mode and in self-drive mode, while autonomous travel mode can be select only in self-drive mode. When drive mode is changed from manual drive mode to self-drive mode, travel mode selected in manual drive mode is reset and then autonomous travel mode is autonomously selected. After that, the travel mode select switch is operated, travel mode in accordance with the switch operation is selected. On the other hand, when drive mode is changed from self-drive mode to manual drive mode, travel mode is autonomously changed to a predetermined mode (for example, normal mode). When autonomous travel mode is selected during following the forward vehicle, any one of economy mode, normal mode and sport mode is autonomously selected as described below.

The GPS unit 34 includes a GPS receiver for receiving position determination signals from multiple GPS satellites, and measures absolute position (latitude, longitude and the like) of the subject vehicle based on the signals received from the GPS receiver.

The map database 35 is a unit storing general map data used by the navigation unit 36 and is, for example, implemented using a hard disk. The map data include road position data and road shape (curvature etc.) data, along with intersection and road branch position data. The map data stored in the map database 35 are different from high-accuracy map data stored in a memory unit 42 of the controller 40.

The navigation unit 36 retrieves target road routes to destinations input by the driver and performs guidance along selected target routes. Destination input and target route guidance is performed through the input-output unit 33. Target routes are computed based on subject vehicle current position measured by the GPS unit 34 and map data stored in the map database 35.

The communication unit 37 communicates through networks including the Internet and other wireless communication networks to access servers (not shown in the drawings) to acquire map data, traffic data and the like, periodically or at arbitrary times. Acquired map data are output to the map database 35 and/or memory unit 42 to update their stored map data. Acquired traffic data include congestion data and traffic light data including, for instance, time to change from red light to green light.

The actuators AC are provided to perform driving of the vehicle 101. The actuators AC include a throttle actuator 13 for adjusting opening angle of the throttle valve of the engine 1 (throttle opening angle) and a shift actuator 23 for changing speed stage of the transmission 2, as shown in FIG. 1, and further include a brake actuator for operating a braking device and a steering actuator for driving a steering unit.

The controller 40 is constituted by an electronic control unit (ECU). In FIG. 2, the controller 40 is integrally configured by consolidating multiple function-differentiated ECUs such as an engine control ECU, a transmission control ECU, a clutch control ECU and so on. Optionally, these ECUs can be individually provided. The controller 40 incorporates a computer including a CPU or other processing unit 41, the memory unit 42 of RAM, ROM, hard disk and the like, and other peripheral circuits not shown in the drawings.

The memory unit 42 stores high-accuracy detailed map data including, inter alia, lane center position data and lane boundary line data. More specifically, road data, traffic regulation data, address data, facility data, telephone number data and the like are stored as map data. The road data include data identifying roads by type such as expressway, toll road and national highway, and data on, inter alia, number of road lanes, individual lane width, road gradient, road 3D coordinate position, lane curvature, lane merge and branch point positions, and road signs. The traffic regulation data include, inter alia, data on lanes subject to traffic restriction or closure owing to construction work and the like. The memory unit 42 also stores a shift map (shift chart) serving as a shift operation reference, various programs for performing processing, threshold values used in the programs, etc., and information on size class of the subject vehicle.

As functional configurations, the processing unit 41 includes a subject vehicle position recognition unit 43, an exterior recognition unit 44, an action plan generation unit 45, and a driving control unit 46.

The subject vehicle position recognition unit 43 recognizes map position of the subject vehicle (subject vehicle position) based on subject vehicle position data calculated by the GPS unit 34 and map data stored in the map database 35. Optionally, the subject vehicle position can be recognized using map data (building shape data and the like) stored in the memory unit 42 and ambience data of the vehicle 101 detected by the external sensor group 31, whereby the subject vehicle position can be recognized with high accuracy. Optionally, when the subject vehicle position can be measured by sensors installed externally on the road or by the roadside, the subject vehicle position can be recognized with high accuracy by communicating with such sensors through the communication unit 37.

The exterior recognition unit 44 recognizes external circumstances around the subject vehicle based on signals from LIDARs, RADARs, cameras and the like of the external sensor group 31. For example, it recognizes position, speed and acceleration of nearby vehicles (forward vehicle or rearward vehicle) driving in the vicinity of the subject vehicle, position of vehicles stopped or parked in the vicinity of the subject vehicle, and position and state of other objects. Other objects include traffic signs, traffic lights, road boundary and stop lines, buildings, guardrails, power poles, commercial signs, pedestrians, bicycles, and the like. Recognized states of other objects include, for example, traffic light color (red, green or yellow) and moving speed and direction of pedestrians and bicycles.

The action plan generation unit 45 generates a subject vehicle driving path (target path) from present time point to a certain time ahead based on, for example, a target route computed by the navigation unit 36, subject vehicle position recognized by the subject vehicle position recognition unit 43, and external circumstances recognized by the exterior recognition unit 44. When multiple paths are available on the target route as target path candidates, the action plan generation unit 45 selects from among them the path that optimally satisfies legal compliance, safe efficient driving and other criteria, and defines the selected path as the target path. The action plan generation unit 45 then generates an action plan matched to the generated target path. An action plan is also called “travel plan”.

The action plan includes action plan data set for every unit time Δt (e.g., 0.1 sec) between present time point and a predetermined time period T (e.g., 5 sec) ahead, i.e., includes action plan data set in association with every unit time Δt interval. The action plan data include subject vehicle position data and vehicle state data for every unit time Δt. The position data are, for example, target point data indicating 2D coordinate position on road, and the vehicle state data are vehicle speed data indicating vehicle speed, direction data indicating subject vehicle direction, and the like. The vehicle state data can be determined from position data change of successive unit times Δt. Action plan is updated every unit time Δt.

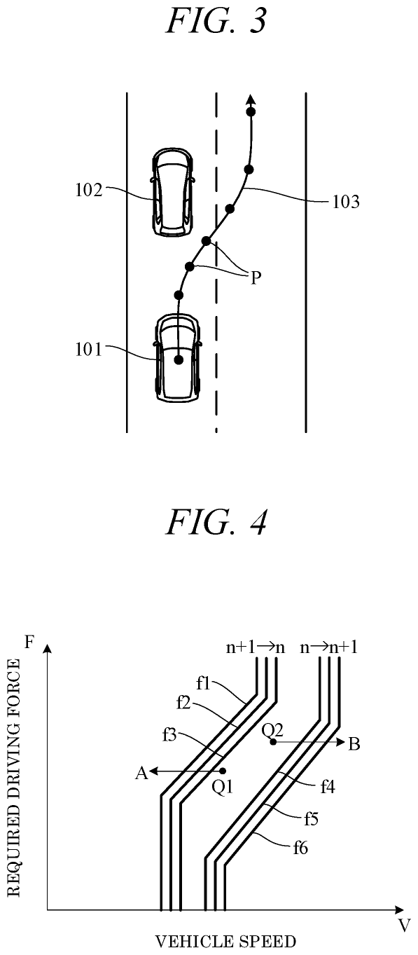

FIG. 3 is a diagram showing an action plan generated by the action plan generation unit 45. FIG. 3 shows a scene depicting an action plan for the subject vehicle 101 when changing lanes and overtaking a vehicle 102 ahead. Points P in FIG. 3 correspond to position data at every unit time Δt between present time point and predetermined time period T1 ahead. A target path 103 is obtained by connecting the points P in time order. The action plan generation unit 45 generates not only overtake action plans but also various other kinds of action plans for, inter alia, lane-changing to move from one traffic lane to another, lane-keeping to maintain same lane and not stray into another, and decelerating or accelerating.

When generating a target path, the action plan generation unit 45 first decides a drive mode and generates the target path in line with the drive mode. When creating an action plan for lane-keeping, for example, the action plan generation unit 45 firsts decides drive mode from among modes such as cruising, overtaking, decelerating, and curve negotiating. To cite particular cases, the action plan generation unit 45 decides cruising mode as drive mode when no other vehicle is present ahead of the subject vehicle (no forward vehicle) and decides following mode as drive mode when a vehicle ahead (forward vehicle) is present. In following mode, the action plan generation unit 45 generates, for example, travel plan data for suitably controlling inter-vehicle distance from the subject vehicle to a forward vehicle in accordance with vehicle speed. The target inter-vehicle distance in accordance with vehicle speed is stored in the memory unit 42 in advance.

In self-drive mode, the driving control unit 46 controls the actuators AC to drive the subject vehicle 101 along target path 103 generated by the action plan generation unit 45. For example, the driving control unit 46 controls the throttle actuator 13, shift actuator 23, brake actuator and steering actuator so as to drive the subject vehicle 101 through the points P of the unit times Δt in FIG. 3.

More specifically, in self-drive mode, the driving control unit 46 calculates acceleration (target acceleration) of sequential unit times Δt based on vehicle speed (target vehicle speed) at points P of sequential unit times Δt on target path 103 (FIG. 3) included in the action plan generated by the action plan generation unit 45. In addition, the driving control unit 46 calculates required driving force for achieving the target accelerations taking running resistance caused by road gradient and the like into account. And the actuators AC are feedback controlled to bring actual acceleration detected by the internal sensor group 32, for example, into coincidence with target acceleration. On the other hand, in manual drive mode, the driving control unit 46 controls the actuators AC in accordance with driving instructions by the driver (accelerator opening angle and the like) acquired from the internal sensor group 32.

Controlling of the transmission 2 by the driving control unit 46 is explained concretely. The driving control unit 46 controls shift operation (shifting) of the transmission 2 by outputting control signals to the shift actuator 23 using a shift map stored in the memory unit 42 in advance.

FIG. 4 is a diagram showing an example of the shift map stored in the memory unit 42, in particular, an example of the shift maps corresponding to economy mode, normal mode, and sport mode in self-drive mode. In the drawing, horizontal axis is scaled for vehicle speed V and vertical axis for required driving force F. Required driving force F is in one-to-one correspondence to accelerator opening angle which is an amount of operation of an accelerator (in self-drive mode, simulated accelerator opening angle) or throttle opening angle, and required driving force F increases with increasing accelerator opening angle or throttle opening angle. Therefore, the vertical axis can instead be scaled for accelerator opening angle or throttle opening angle.

Characteristic curves f1, f2 and f3 are an example of downshift curves corresponding to downshift from “n+1” speed stage to “n” speed stage in economy mode, normal mode and sport mode, respectively, and characteristic curves f4, f5 and f6 are an example of upshift curves corresponding to upshift from “n” speed stage to “n+1” speed stage in economy mode, normal mode and sport mode. Characteristic curves f3 and f6 in sport mode are shifted to high vehicle speed side than characteristic curves f2 and f5 in normal mode, respectively. Characteristic curves f1 and f4 in economy mode are shifted to low vehicle speed side than characteristic curves f2 and f5 in normal mode, respectively.

For example, considering downshift from operating point Q1 as shown in FIG. 4, in a case where vehicle speed V decreases under constant required driving force F, the transmission 2 downshifts from “n+1” speed stage to “n” speed stage when operating point Q1 crosses downshift curves (characteristics f1, f2 and f3) (arrow A). Also, in a case where required driving force F increases under constant vehicle speed V, the transmission 2 downshifts when operating point Q1 crosses downshift curve.

On the other hand, considering upshift from operating point Q2, in a case where vehicle speed V increases under constant required driving force F, the transmission 2 upshifts from “n” stage to “n+1” stage when operating point Q2 crosses upshift curves (characteristic curves f4, f5 and f6; arrow B). Also, in a case where required driving force F decreases under constant vehicle speed V, the transmission 2 upshifts when operating point Q1 crosses upshift curves. Downshift curves and upshift curves are shifted to high speed side along with an increase of speed stage.

Characteristic curves f2 and f5 in normal mode are characteristic curves that balance fuel economy performance and power performance. On the other hand, characteristic curves f1 and f4 in economy mode are characteristic curves that prioritizes fuel economy performance or silent performance over power performance, and characteristic curves f3 and f6 in sport mode are characteristic curves that power performance over fuel economy performance. Since characteristic curves f1 and f4 are shifted to low vehicle speed side than characteristic curves f2 and f5, upshift time is advanced and downshift time is delayed in economy mode. Therefore, the subject vehicle in economy mode tends to travel at speed stage greater than in normal mode (at high speed stage side), and acceleration response in economy mode is low. On the other hand, since characteristic curves f3 and f6 are shifted to high vehicle speed side than characteristic curves f2 and f5, upshift time is delayed and downshift time is advanced in sport mode. Therefore, the subject vehicle in economy mode tends to travel at speed stage smaller than in normal mode (at low speed stage side), and acceleration response in economy mode is high.

Although not shown in the drawings, shift maps corresponding to economy mode, normal mode and sport mode in manual drive mode are stored in the memory unit 42. These characteristic curves in manual drive mode are the same as characteristic curves in self-drive mode (FIG. 4). Optionally, characteristic curves in manual drive mode can be different from characteristic curves in self-drive mode.

A point requiring attention here is that when the subject vehicle follows the forward vehicle of a size class different from the subject vehicle, the fact that the two vehicles differ substantially in some aspects of travel performance, such as in acceleration performance, makes optimum vehicle following at target inter-vehicle distance difficult to achieve. For example, when the subject vehicle is a family-type passenger car and the forward vehicle is a low-profile sports-type passenger car, acceleration performance of the forward vehicle almost certainly excels that of the subject vehicle. And when the subject vehicle is a standard size car and the forward vehicle is a large truck, acceleration performance of the subject vehicle can be safely assumed to excel that of the forward vehicle.

When such a difference in acceleration performance is present, the subject vehicle may, for example, fall behind the forward vehicle and/or experience continuous unnecessarily high engine speed, so that it is difficult to perform good vehicle-following that achieves an optimum combination of inter-vehicle distance control, fuel economy and quiet performance. The travel control apparatus according to the present embodiment is therefore configured as set out below in order to enable excellent vehicle-following even when the subject vehicle and the forward vehicle are of different size class.

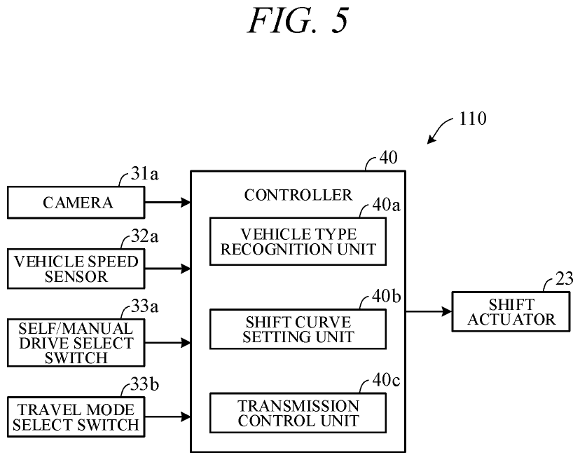

FIG. 5 is a block diagram showing main components of the travel control apparatus 110 according an embodiment of the present invention. The travel control apparatus 110, which serves as one part of the vehicle control system 100 of FIG. 2, is primarily configured to control shift change under self-driving mode. Configurations in common with those of FIG. 2 are assigned like reference symbols in FIG. 5. As shown in FIG. 5, the controller 40 receives signals from a camera 31a among members of the external sensor group 31, signals from a vehicle speed sensor 32a among members of the internal sensor group 32, and signals from a self/manual drive select switch 33a and travel mode select switch 33b among members of the input-output unit 33.

As functional configurations, the controller 40 includes a vehicle type recognition unit 40a, shift curve setting unit 40b and transmission control unit 40c. These vehicle type recognition unit 40a, shift curve setting unit 40b and transmission control unit 40c are configured by, for example, the driving control unit 46 of FIG. 2.

The vehicle type recognition unit 40a uses signals from the camera 31c to recognize type of the forward vehicle to be followed. A number of vehicle type candidates are prepared in advance and vehicle type is decided from among the candidates in accordance with vehicle height, width and other size class features. For example, vehicle size features can be used to determine type of the forward vehicle from among candidates including large-size vehicle, medium-size vehicle, standard size vehicle, compact vehicle, light four-wheeled vehicle, and two-wheeled vehicle. Other possible vehicle type candidates include low-profile sports-type passenger car and high-profile family car. Optionally, vehicle type can be decided based on displacement of the engine 1. Relation between vehicle type and acceleration performance level is stored in the memory unit 42 in advance, so that once vehicle type of the forward vehicle is recognized (determined), it is possible to estimate acceleration performance level (acceleration response and the like) of the forward vehicle. The memory unit 42 also stores acceleration performance level of the subject vehicle.

When switching to self-drive mode is instructed via the self/manual drive select switch 33a and autonomous travel mode is instructed via the travel mode select switch 33b, the shift curve setting unit 40b defines a shift curve serving as a standard for speed stage shifting of the transmission 2 in response to vehicle type recognized by the vehicle type recognition unit 40a. In other words, the shift curve setting unit 40b calculates difference between acceleration performance level of the subject vehicle and acceleration performance level of the forward vehicle estimated from vehicle type recognized by the vehicle type recognition unit 40a. When the calculated difference is not greater than a predetermined value, the shift curve setting unit 40b establishes normal mode characteristics (f2, f5 in FIG. 4).

When difference between acceleration performance levels of the subject vehicle and the forward vehicle is greater than the predetermined value and acceleration performance level of the subject vehicle is the greater (when acceleration performance of the subject vehicle is high), the shift curve setting unit 40b establishes eco-mode (economical mode) characteristics (f1, f4 in FIG. 4). When difference between acceleration performance levels of the subject vehicle and the forward vehicle is greater than predetermined value and acceleration performance level of vehicle ahead is the greater (acceleration performance of the subject vehicle is low), the shift curve setting unit 40b establishes sport mode characteristics (f3, f6 in FIG. 4). Acceleration performance level is, for example, expressed as acceleration response, such as degree of engine speed increase or degree of vehicle speed increase relative to acceleration instruction value.

The transmission control unit 40c outputs a control signal to the shift actuator 23 in accordance with the shift curves established by the shift curve setting unit 40b, thereby controlling speed stage of the transmission 2. More exactly, vehicle speed V detected by the vehicle speed sensor 32a and required driving force F generated by the action plan generation unit 45 are used to upshift or downshift the transmission 2 in accordance with one of the characteristic curves in FIG. 4.

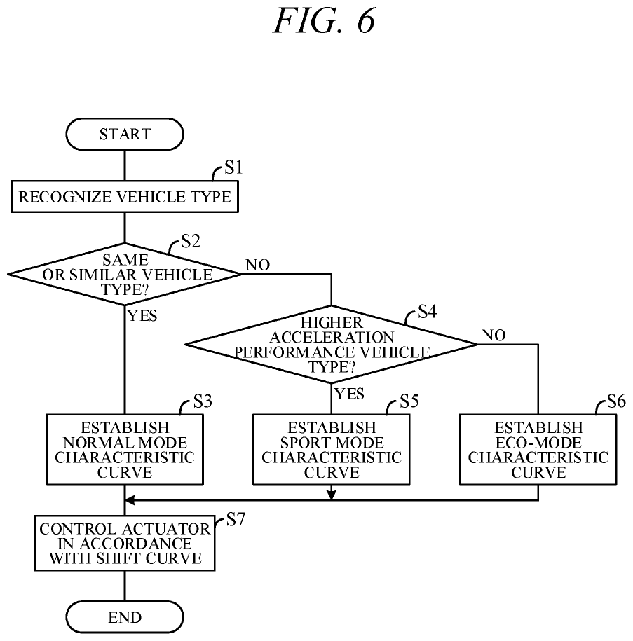

FIG. 6 is a flowchart showing an example of processing performed by the controller 40 of FIG. 5 in accordance with a program stored in the memory unit 42 in advance. Processing shown in this flowchart is started during vehicle-following, when, for example, transition to self-drive mode is instructed by the self/manual drive select switch 33a and autonomous travel mode is instructed by the travel mode select switch 33b, and is repeated at predetermined intervals.

First, in S1, the vehicle type recognition unit 40a recognizes type of a forward vehicle based on a rear image of the forward vehicle taken by the camera 31a. Next, in S2, the shift curve setting unit 40b first calculates (estimates) difference between acceleration performance level of the subject vehicle and acceleration performance level corresponding to vehicle type recognized in S1 and then determines whether the calculated difference is equal to or less than a predetermined value, i.e., whether the forward vehicle is of a vehicle type approximate to subject vehicle type. When the result in S2 is YES, the program goes to S3, in which normal mode characteristic curves f2, f5 are established as shift curves.

On the other hand, when the result in S2 is NO, the program goes to S4, in which whether acceleration performance level of the forward vehicle is higher than acceleration performance level of the subject vehicle, i.e., whether the forward vehicle is a high acceleration performance vehicle type (fast accelerating vehicle type), is determined. When the result in S4 is YES, the program goes to S5, in which sport mode characteristic curves f3, f6 are established as shift curves. When, to the contrary, the result in S4 is NO, the program goes to S6, in which eco-mode characteristic curves f1, f4 are established as shift curves.

In S7, the transmission control unit 40c outputs a control signal to the shift actuator 23 in accordance with the shift curves established in either S3, S5 or S6, thereby controlling speed stage shifting (upshift/downshift) of the transmission 2.

There now follows a concrete explanation of main actions of the travel control apparatus according to the present embodiment. The actions are explained for the case of the subject vehicle being an ordinary vehicle (e.g., a family car). Once the vehicle control system 100 implements vehicle-following with respect to the forward vehicle while in self-drive mode and autonomous travel mode, vehicle type of the forward vehicle is identified (S1). When the forward vehicle is of ordinary vehicle type approximate to the subject vehicle, acceleration performance (acceleration response and the like) does not differ greatly between the forward vehicle and the subject vehicle, so normal mode shift characteristics are established (S3). As a result, the subject vehicle can follow the forward vehicle while striking good balance between fuel economy performance and power performance.

On the other hand, when the forward vehicle is of low-profile sports car type, for example, the forward vehicle is estimated to be the one with higher acceleration performance, and sport mode shift characteristics are therefore established to enhance subject vehicle acceleration performance (S5). Since the subject vehicle therefore assumes a travel mode giving priority to power performance, it can follow acceleration of the forward vehicle without falling behind and thus achieve optimum vehicle-following.

Further, when the forward vehicle is of light four-wheeled vehicle type, for example, the subject vehicle is estimated to be the one with higher acceleration performance, and eco-mode shift characteristics are therefore established (S6). In other words, since high acceleration performance is unnecessary in this case, travel mode is set to eco-mode in order to maximize subject vehicle fuel economy performance. Since this facilitates upshift of the transmission 2 and avoidance of increased engine speed, fuel economy can be increased while also minimizing noise.

The present embodiment can achieve advantages and effects such as the following:

(1) The travel control apparatus 110 of the self-driving vehicle 101 having the engine 1 and the transmission 2 installed in a power transmission path from the engine 1 to the drive wheels 3 (FIG. 1). The travel control apparatus 110 includes the controller 40 that controls the engine 1 and the transmission 2 so as to follow the forward vehicle, and the camera 31a that detects size class of the forward vehicle (FIGS. 2 and 5). The controller 40 includes the transmission control unit 40c that controls speed stage shifting of the transmission 2 in accordance with the size class detected by the camera 31a (FIG. 5). Therefore, even when class size of the subject vehicle is different from class size of the forward vehicle, the subject vehicle can optimally follow the forward vehicle.

(2) The controller 40 further includes the vehicle type recognition unit 40a that recognizes vehicle type of the forward vehicle in accordance with the size class detected by the camera 31a (FIG. 5). The transmission control unit 40c controls speed stage shifting of the transmission 2 in accordance with the vehicle type recognized by the vehicle type recognition unit 40a. Therefore, it is possible to achieve optimum vehicle-following with a simple configuration in which vehicle type of the forward vehicle is identified from among multiple vehicle types classified in advance.

(3) The controller 40 further includes the shift curve setting unit that sets shift curve corresponding to the vehicle type recognized by the vehicle type recognition unit 40a (FIG. 5). The transmission control unit 40c controls speed stage shifting of the transmission 2 in accordance with the shift curve set by the shift curve setting unit 40b. Therefore, since the transmission 2 is upshifted or downshifted in accordance with predetermined shift map, speed stage can be changed to optimum speed stage for vehicle-following.

(4) The shift curve setting unit 40b sets the shift curve corresponding to either eco-mode in which fuel economy performance is prioritized over power performance, normal mode in which fuel economy performance and power performance are balanced, or sport mode in which power performance is prioritized over fuel economy performance. Therefore, when travel mode is automatically set, optimum shift curve for vehicle-following can be set with a simple configuration.

(5) The travel control apparatus 110 which is a part of the vehicle control system 100, further includes the memory unit 42 that stores in advance information on acceleration performance of the self-driving vehicle 101 and information on acceleration performance of each of vehicle types (FIG. 2). The shift curve setting unit 40b calculates difference between acceleration performance level of the subject vehicle and acceleration performance level of the vehicle type recognized by the vehicle type recognition unit 40a based on the information stored by the memory unit 42, and in accordance with the calculated difference, sets shift curve corresponding to either the eco-mode, the normal mode or the sport mode. Therefore, when the subject vehicle is of vehicle type approximate to the forward vehicle and difference between acceleration performance levels (acceleration response) of the subject vehicle and the forward vehicle is equal to or lower than the predetermined value, travel mode becomes normal mode. Accordingly, it is possible to achieve vehicle-following with fuel economy performance and power performance balanced. On the other hand, when the difference between acceleration performance levels is greater than the predetermined value and acceleration performance level of the subject vehicle is lower than acceleration performance level of the forward vehicle (for example, when vehicle type of the forward vehicle is low-profile sports-type), travel mode becomes sport mode. Accordingly, the subject vehicle can follow acceleration of the forward vehicle without falling behind. Furthermore, when the difference between acceleration performance levels is greater than the predetermined value and acceleration performance level of the subject vehicle is greater than acceleration performance level of the forward vehicle (for example, when vehicle type of the forward vehicle is light four-wheeled vehicle type while vehicle type of the subject vehicle is ordinary vehicle type), travel mode becomes eco-mode. Accordingly, fuel economy can be increased while also minimizing noise.

Various modifications of the aforesaid embodiment are possible. Examples are explained below. Although in the aforesaid embodiment, seize class of the forward vehicle is detected by the camera 31a, a vehicle class detection part is not limited to the aforesaid configuration. Vehicle type or size class may be detected, for example, taking into account vehicle-following level in the most recently performed vehicle-following, more specifically, time delay for maintaining inter-vehicle distance from the subject vehicle to the forward vehicle to a constant distance, margin of driving force, or the like. In aforesaid embodiment, speed stage of the transmission 2 is controlled in accordance with the shift curve set by the shift curve setting unit 40b. However, as long as controlling a speed ratio of the transmission in accordance with a size class detected by a vehicle class detection part, a transmission control unit is not limited to the aforesaid configuration. For example, a speed ratio may be controlled to high side or low side in accordance with a degree of difference between size classes (vehicle height, width or the like) of the subject vehicle and the forward vehicle without recognizing vehicle type.

Although in the aforesaid embodiment, the transmission 2 is configured as a stepped transmission, it may be configured as a continuously variable transmission. As a drive power source, a travel motor may be used instead of the engine 1 or in addition to the engine 1. In other words, as long as controlling the drive power source and the transmission so as to follow a forward vehicle, the controller 40 as a control unit is not limited to the aforesaid configuration. In the aforesaid embodiment, the shift curve setting unit 40b establishes a shift curve corresponding to one of eco-mode (a first travel mode), normal mode (a second travel mode) and sport mode (a third travel mode). However, a shift curve setting unit may set shift curves in accordance with vehicle types other than the shift curves corresponding to travel modes. In the aforesaid embodiment, one of the travel modes is set in response to selection by the travel mode select switch 33b. However, the travel mode select switch 33b may be omitted and a predetermined travel mode may be set.

The above explanation is an explanation as an example and the present invention is not limited to the aforesaid embodiment or modifications unless sacrificing the characteristics of the invention. The aforesaid embodiment can be combined as desired with one or more of the aforesaid modifications. The modifications can also be combined with one another.

### REFERENCE SIGNS LIST

1 engine, 2 transmission, 31a camera, 40 controller, 40a vehicle type recognition unit, 40b shift curve setting unit, 40c transmission control unit, 110 travel control apparatus

1-5. (canceled)

6. A travel control apparatus of a self-driving vehicle having a drive power source, drive wheels and a transmission installed in a power transmission path from the drive power source to the drive wheels,
the travel control apparatus comprising:
a vehicle class detection part configured to detect a size class of a forward vehicle in front of the self-driving vehicle; and
an electronic control unit having a microprocessor and a memory, wherein
the microprocessor is configured to perform
controlling the drive power source and the transmission so as to follow the forward vehicle,
recognizing a vehicle type of the forward vehicle in accordance with the size class detected by the vehicle class detection part, and
the controlling including controlling a speed ratio of the transmission in accordance with the vehicle type recognized in the recognizing.

7. The travel control apparatus of the self-driving vehicle according to claim 6, wherein
the microprocessor is configured to further perform
setting a shift curve corresponding to the vehicle type recognized in the recognizing, and
the controlling including controlling the speed ratio of the transmission in accordance with the shift curve set in the setting.

8. The travel control apparatus of the self-driving vehicle according to claim 7, wherein
the microprocessor is configured to perform
the setting including setting the shift curve corresponding to one of a plurality of travel modes including a first travel mode in which a fuel economy performance is prioritized over a power performance, a second travel mode in which the fuel economy performance and the power performance are balanced, and a third travel mode in which the power performance is prioritized over the fuel economy performance.

9. The travel control apparatus of the self-driving vehicle according to claim 8, further comprising
a memory unit configured to store in advance an information on an acceleration performance of the self-driving vehicle and an information on an acceleration performance corresponding to each of a plurality of vehicle types, wherein
the microprocessor is configured to perform
the setting including calculating a difference between a level of the acceleration performance of the self-driving vehicle and a level of the acceleration performance corresponding to the vehicle type recognized in the recognizing, based on the information stored by the storage unit, and setting the shift curve corresponding to one of the first travel mode, the second travel mode and the third travel mode, in accordance with the difference.

10. The travel control apparatus of the self-driving vehicle according to claim 8, further comprising
a select switch configured to select one of the first travel mode, the second travel mode, the third travel mode and an autonomous travel mode in accordance with an operation by an occupant,
the microprocessor is configured to perform
when one of the first travel mode, the second travel mode and the third travel mode is selected by the select switch, the controlling including controlling the speed ratio of the transmission in accordance with the shift curve corresponding to a selected travel mode, and when the autonomous travel mode is selected by the select switch, the controlling including controlling the speed ratio of the transmission in accordance with the shift curve corresponding to the vehicle type recognized in the recognizing.

11. The travel control apparatus of the self-driving vehicle according to claim 8, wherein
the shift curve corresponding to the first travel mode is a first shift curve defined in accordance with a vehicle speed and a required driving force of the self-driving vehicle,
the shift curve corresponding to the second travel mode is a second shift curve defined in accordance with the vehicle speed and the required driving force and shifted toward a higher vehicle speed side than the first shift curve, and
the shift curve corresponding to the third travel mode is a third shift curve defined in accordance with the vehicle speed and the required driving force and shifted toward the higher speed side than the second shift curve.

12. The travel control apparatus of the self-driving vehicle according to claim 6, wherein
the vehicle class detection part is an on-board camera configured to detect a width or height of the forward vehicle.

13. A travel control method of a self-driving vehicle having a drive power source, drive wheels and a transmission installed in a power transmission path from the drive power source to the drive wheels,
the travel control method comprising:
controlling the drive power source and the transmission so as to follow a forward vehicle in front of the self-driving vehicle;
detecting a size class of the forward vehicle; and
recognizing a vehicle type of the forward vehicle in accordance with the size class, wherein
the controlling includes controlling a speed ratio of the transmission in accordance with the vehicle type recognized in the recognizing.
